(19) United States
(12) Patent Application Publication
(10) Pub. No.: US 2006/0143712 A1
(43) Pub. Date: Jun. 29, 2006

(54) Method and apparatus for the early detection of machines infected by e-mail based computer viruses

(76) Inventors: Eric Henry Grosse, Berkeley Heights, NJ (US); David Leo Presotto, Palo Alto, CA (US)

Correspondence Address: Lucent Technologies Inc.;Docket Administrator - Room 3J-219, 101 Crawfords Corner Road, Holmdel, NJ, 07733-3030, US

(21) Appl. No.: 11/021,061

(22) Filed: Dec. 23, 2004

(51) Int. Cl. G06F 12/14

(52) U.S. Cl. 726/24

(57) ABSTRACT

A method and apparatus for the early detection of machines infected by e-mail based computer viruses advantageously employs a network behavioral analysis rather than a direct technical analysis of attached executable code. Specifically, an SMTP (Simple Mail Transfer Protocol) log associated with a mail gateway system interconnected to a plurality of machines is examined, and based on an analysis of information comprised in a plurality of log entries thereof, it may be determined that one of these machines has a possible infection by an e-mail based computer virus. Illustratively, information extracted from each entry in the SMTP log (i.e., for each incoming e-mail message) of the mail gateway includes (i) the unique identity of the sending machine; (ii) the “hello” name that the sending machine calls itself, (iii) the e-mail “From:” address; and (iv) whether the message contains a potentially virus-like (e.g., executable) attachment.

### FIELD OF THE INVENTION

The present invention relates generally to the field of computer virus detection and more particularly to a method and apparatus for the early detection of machines infected by e-mail based viruses.

### BACKGROUND OF THE INVENTION

Over the past ten years or so, e-mail has become a vital communications medium. Once limited to specialists with technical backgrounds, its use has rapidly spread to ordinary consumers. E-mail now provides serious competition for all other forms of written and electronic communication. Unfortunately, as its popularity has grown, so has its abuses. One of the most significant problems is that of computer viruses that propagate via e-mail. For example, it has been estimated that computer viruses cost companies worldwide billions of dollars per year.

Specifically, the most common mechanism used to “infect” computers across a network is to attach the executable code for a virus to an e-mail message. Then, when the e-mail in question is opened, the virus accesses the information contained in the user's address book and mails a copy of itself to all of the user's associates. Since such messages may seem to come from a reliable source, the likelihood the infection will be spread by unwitting recipients is greatly increased.

Present solutions to the virus problem usually focus on an analysis of the executable code which is attached to the e-mail message. In particular, most virus detection techniques work by either matching virus “signatures” against the instruction bytes of the executable file, or by recognizing the pattern of system calls during the execution of the executable file. In addition, such analyses are typically performed on an end-point host or by scanning a file as it transits a network.

More specifically, the most common virus detection utilities typically maintain a list of signature patterns of known, previously detected viruses. Then, when incoming e-mail with attached executable code is received, these previously identified signature patterns are compared to those found in the executable code. If a match is found, the e-mail is tagged as infected and may be filtered out. Unfortunately, although this approach works well for known viruses, it is essentially useless against a new, previously undetected and unknown virus.

For protection against such new (previously undetected) viruses, it has been suggested that machine learning techniques may be used in an attempt to classify strings of byte patterns as potentially deriving from a virus. Then such classified patterns will be filtered in the same manner as if they were a signature of a known virus. However, such techniques will necessarily only succeed in accurately identifying a virus some of the time, and such a failure means that in some cases viruses will get through (if the filter is too porous), that legitimate messages will get stopped (if the filter is too fine), or both.

### SUMMARY OF THE INVENTION

In accordance with the principles of the present invention, a novel method for the early detection of machines infected by e-mail based computer viruses advantageously employs a network behavioral analysis rather than a direct technical analysis of attached executable code. In particular, the effects of a computer virus on an infected machine are advantageously detected by identifying anomalous behavior in the network.

Specifically, an SMTP (Simple Mail Transfer Protocol) log associated with a mail gateway system interconnected to a plurality of machines is examined, and based on an analysis of information comprised in a plurality of log entries thereof, it may be determined that one of these machines has a possible infection by an e-mail based computer virus. (As is well known to those skilled in the art, SMTP is a standard protocol for use in sending e-mail messages between servers and between a server and a client, and is used by most e-mail systems that send mail over the Internet.)

### BRIEF DESCRIPTION OF THE DRAWINGS

FIG. 1 shows a flowchart of an illustrative method for the early detection of e-mail based computer virus attacks.

### DETAILED DESCRIPTION OF THE ILLUSTRATIVE EMBODIMENTS

In accordance with an illustrative embodiment of the present invention, the SMTP (Simple Mail Transfer Protocol) log of a mail gateway system is analyzed, advantageously in “real time” (i.e., continuously as the log file is being generated). Other illustrative embodiments of the invention may analyze previously stored log files, although it is preferable to do so either as the log files entries are entered or as soon as possible thereafter. As is well known to those skilled in the art, a mail gateway—also known as a mail relay—is a system which is typically located at a particular place in a network (such as, for example, an enterprise network), which accepts e-mail from various users and undertakes the burden of trying to send the e-mail onward to its intended destination.

In particular, in accordance with the illustrative embodiment of the present invention, the following specific information is advantageously extracted from each entry in the SMTP log (i.e., for each incoming e-mail message) of the mail gateway:

(i) M=the unique identity of the sending machine, such as, for example, the IP (Internet Protocol) address;

(ii) H=the “hello” name that the sending machine calls itself. (As is well known to those skilled in the art, the SMTP protocol specifies that at the time a transmission channel is opened, there is an exchange to ensure that the hosts are communicating with the hosts with which they expect to be communicating. Included in such an exchange is a command known as the “HELO” command in which the host sending the command identifies itself “by name.” This identity is commonly referred to as the “hello” name.);

(iii) F=the e-mail address given in the “From:” address line of the incoming e-mail message; and

(iv) V=whether or not the incoming e-mail message contains a potentially virus-like (e.g., executable) attachment.

Then, in accordance with the illustrative embodiment of the invention, for each different value of M extracted from the SMTP log entries (i.e., for each unique e-mail message sending machine), the following values are advantageously calculated (by examining the log entries for which the identity of the sending machine is equal to M):

(i) #H=the number of different values of H (i.e., “hello” names) which have been associated with e-mail messages from machine M contained in the log entries representing e-mail messages received in the past week;

(ii)*H=the number of different values of H (i.e., “hello” names) which have been associated with e-mail messages from machine M contained in the log entries representing e-mail messages received in the past twelve hours;

(iii) #F=the number of different values of F (i.e., “From:” addresses) which have been associated with e-mail messages from machine M contained in the log entries representing e-mail messages received in the past month;

(iv)*F=the number of different values of F (i.e., “From:” addresses) which have been associated with e-mail messages from machine M contained in the log entries representing e-mail messages received in the past half hour;

(v) #V=the number of e-mail messages from machine M that have contained possible virus-like (e.g., executable) attachment identified in the log entries representing e-mail messages received in the past day; and

(vi)*V=the number of e-mail messages from machine M that have contained possible virus-like (e.g., executable) attachment identified in the log entries representing e-mail messages received in the past hour.

Note that all of these values can be easily determined and maintained in a single analysis pass over the SMTP log.

In accordance with the illustrative embodiment of the present invention, once the above values are calculated for a given machine M, a number of (mathematical) tests may be advantageously performed on these values to determine a possible infection by an e-mail based computer virus of the machine M. In particular, in accordance with the illustrative embodiment, each of the following tests are advantageously performed:

(i) if *H>1 and M is not a mail gateway system, then identify M as potentially infected by an e-mail based computer virus. (Note that mail gateway systems are advantageously “excluded” from this test since such machines more naturally have a lot of names and also tend to be better maintained and hence less likely to be infected. That is, by the nature of a mail gateway, it will probably be sending messages with a lot of user names and possibly a lot of domains. On the other hand, infected machines often lie about their “hello” name and will therefore use more than one. Note also that techniques for determining whether a given machine is a mail gateway will be familiar to those skilled in the art—for example, one can test to see if the given machine is listening on its SMTP port, since a newly infected machine typically sends e-mail but doesn't act as a mail server.);

(ii) else if *V>0 and M is not a mail gateway system, then identify M as potentially infected by an e-mail based computer virus. (Note again that mail gateway systems are advantageously “excluded” from this test as well for the same reasons as above.);

(iii) else if *F>#F/7 and *F>5, then identify M as potentially infected by an e-mail based computer virus. In other words, if more than five different “From:” addresses have been associated with e-mail messages from machine M contained in the log entries representing e-mail messages received in the past half hour, and the number of different “From:” addresses which have been associated with e-mail messages from machine M contained in the log entries representing e-mail messages received in the past half hour exceeds one-seventh of the number of “From:” addresses which have been associated with e-mail messages from machine M contained in the log entries representing e-mail messages received in the past month, then it is likely that the given machine M is infected with an e-mail based computer virus.

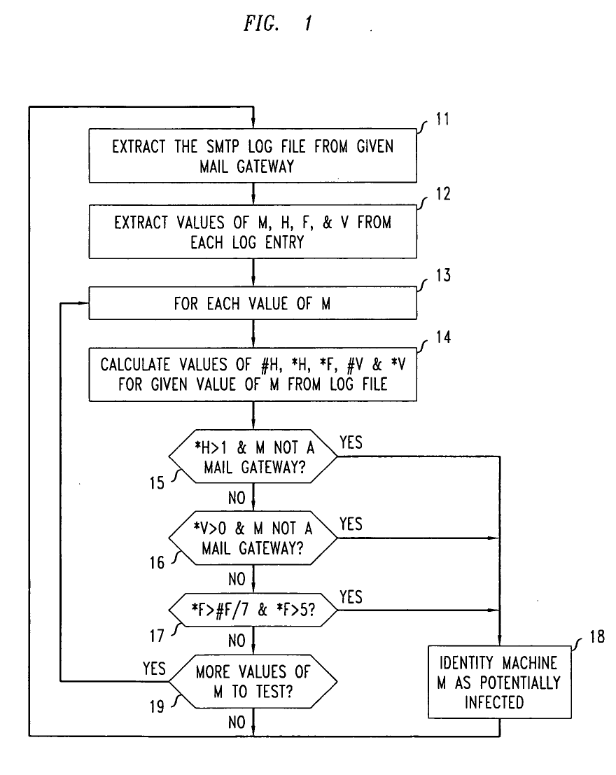

FIG. 1 shows a flowchart of an illustrative method for the early detection of e-mail based computer virus attacks according the illustrative embodiment of the present invention described above. Specifically, as shown in block 11 of the FIGURE, the SMTP log associated with the given mail gateway system is extracted for analysis. Then, as shown in block 12 of the FIGURE, each of the four parameters described above—namely, (i) M, the unique identity of the sending machine; (ii) H, the “hello” name that the sending machine calls itself; (iii) F, the e-mail address given in the “From:” address line of the incoming message; and (iv) V, whether or not the incoming e-mail message contains a potentially virus-like (e.g., executable) attachment—is extracted from each entry (which represents an incoming e-mail message) of the log file.

Next, for each value of M (i.e., for each sending machine) iterated by block 13 of the FIGURE, each of the above-described six values are calculated (as shown in block 14 of the FIGURE) by analyzing the set of extracted log entries which have M as their identified sending machine. Specifically, the values which are calculated are (i) #H, the number of different values of H (i.e., “hello” names) over the past week; (ii)*H, the number of different values of H (i.e., “hello” names) over the past twelve hours; (iii) #F=the number of different values of F (i.e., “From:” addresses) over the past month; (iv)*F, the number of different values of F (i.e., “From:” addresses) over the past half hour; (v) #V, the number of e-mail messages that have contained a possible virus-like (e.g., executable) attachment received in the past day; and (vi)*V, the number of e-mail messages that have contained a possible virus-like (e.g., executable) attachment received in the past hour.

Then, in accordance with the illustrative embodiment of the present invention shown in FIG. 1, also for each value of M (i.e., for each sending machine), each of the three above-described “tests” is advantageously performed to identify a possible e-mail based virus infection of the given machine M. First, as shown in decision block 15 of the FIGURE, if *H (the number of different values of “hello” names over the past twelve hours) is greater than one and if M is not a mail gateway, then flow proceeds to block 18 to report a possible e-mail based virus infection of machine M. Otherwise, flow continues to decision block 16 of the FIGURE, where if *V (the number of messages containing a possible virus-like attachment received in the past hour) is greater than zero and if M is not a mail gateway, then flow proceeds to block 18 to report a possible e-mail based virus infection of machine M. Otherwise, flow continues to decision block 17 of the FIGURE, where if *F (the number of different values of “From:” addresses over the past half hour) is greater than #F (the number of different values of “From:” addresses over the past month) divided by seven and if *F (the number of different values of “From:” addresses over the past half hour) is greater than five, then flow proceeds to block 18 to report a possible e-mail based virus infection of machine M. Otherwise, flow proceeds to block 19 to indicate that no potential e-mail based virus infection of machine M has been identified, and the next value of M (i.e., sending machine) is tested (if more values of M remain to be tested).

Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. Furthermore, all examples and conditional language recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

Thus, for example, it will be appreciated by those skilled in the art that any flow charts, flow diagrams, state transition diagrams, pseudocode, and the like represent various processes which may be substantially represented in computer readable medium and so executed by a computer or processor, whether or not such computer or processor is explicitly shown. Thus, the blocks shown, for example, in such flowcharts may be understood as potentially representing physical elements, which may, for example, be expressed in the instant claims as means for specifying particular functions such as are described in the flowchart blocks. Moreover, such flowchart blocks may also be understood as representing physical signals or stored physical data, which may, for example, be comprised in such aforementioned computer readable medium such as disc or semiconductor storage devices.

We claim:

1. A method for determining a possible infection by an e-mail based computer virus of one of a plurality of machines interconnected via a communications network to a mail gateway system, the method comprising the steps of:
examining an SMTP log associated with the mail gateway system, the SMTP log comprising a sequence of log entries each comprising information relating to a corresponding item of incoming e-mail to said mail gateway system;
determining that one of said plurality of interconnected machines has a possible infection by an e-mail based computer virus based on an analysis of said information comprised in a plurality of said log entries.

2. The method of claim 1 wherein said information comprised in each of said log entries includes a unique identity of a sending machine of said corresponding item of incoming e-mail, and further includes one or more of
(a) a name that said sending machine of said corresponding item of incoming e-mail calls itself,
(b) a “From:” address of said corresponding item of incoming e-mail, and
(c) an indication of whether said corresponding item of incoming e-mail contains a potentially virus-like attachment.

3. The method of claim 2 wherein said unique identity of said sending machine comprises an Internet Protocol address.

4. The method of claim 2 wherein said information comprised in each of said log entries includes said name that said sending machine calls itself, and wherein said name that said sending machine calls itself comprises a “hello” name in accordance with a Simple Mail Transfer Protocol.

5. The method of claim 2 wherein said information comprised in each of said log entries includes said potentially virus-like attachment, and wherein said potentially virus-like attachment comprises an executable file.

6. The method of claim 2 wherein said analysis of said information comprised in a plurality of said log entries comprises calculating, for a given one of said sending machines, one or more of
(a) a number of different values of said names that said given one of said sending machines calls itself which are included in one or more items of incoming e-mail from said given one of said machines which have been received over one or more specified periods of time,
(b) a number of different values of said “From:” addresses included in one or more items of incoming e-mail from said given one of said machines which have been received over one or more specified periods of time, and
(c) a number of items of incoming e-mail from said given one of said machines which contain a potentially virus-like attachment and which have been received over one or more specified periods of time.

7. The method of claim 6 wherein said analysis of said information comprised in a plurality of said log entries comprises calculating, for a given one of said sending machines,
(i) a number of different values of said names that said given one of said sending machines calls itself which are included in one or more items of incoming e-mail from said given one of said machines which have been received over a period of one week,
(ii) a number of different values of said names that said given one of said sending machines calls itself which are included in one or more items of incoming e-mail from said given one of said machines which have been received over a period of twelve hours,
(iii) a number of different values of said “From:” addresses included in one or more items of incoming e-mail from said given one of said machines which have been received over a period of one month,
(iv) a number of different values of said “From:” addresses included in one or more items of incoming e-mail from said given one of said machines which have been received over a period of a half hour,
(v) a number of items of incoming e-mail from said given one of said machines which contain a potentially virus-like attachment and which have been received over a period of one day, and
(vi) a number of items of incoming e-mail from said given one of said machines which contain a potentially virus-like attachment and which have been received over a period of one hour.

8. The method of claim 7 wherein said given one of said sending machines is determined to have a possible infection by an e-mail based computer virus when
(a) said number of different values of said names that said given one of said sending machines calls itself which are included in one or more items of incoming e-mail from said given one of said machines which have been received over a period of twelve hours is greater than one, and
(b) said given one of said sending machines is not a mail gateway system.

9. The method of claim 7 wherein said given one of said sending machines is determined to have a possible infection by an e-mail based computer virus when
(a) said number of items of incoming e-mail from said given one of said machines which contain a potentially virus-like attachment and which have been received over a period of one hour is greater than zero, and
(b) said given one of said sending machines is not a mail gateway system.

10. The method of claim 7 wherein said given one of said sending machines is determined to have a possible infection by an e-mail based computer virus when
(a) said number of different values of said “From:” addresses included in one or more items of incoming e-mail from said given one of said machines which have been received over a period of a half hour is greater than the quotient of said number of different values of said “From:” addresses included in one or more items of incoming e-mail from said given one of said machines which have been received over a period of one month divided by seven, and
(b) said number of different values of said “From:” addresses included in one or more items of incoming e-mail from said given one of said machines which have been received over a period of a half hour is greater than five.

11. A mail gateway system adapted to determine a possible infection by an e-mail based computer virus of one of a plurality of machines interconnected via a communications network thereto, the mail gateway system comprising:
a memory containing an SMTP log, the SMPTP log comprising a sequence of log entries each comprising information relating to a corresponding item of incoming e-mail to said mail gateway system; and
a processor, wherein the processor is adapted to:
examine the SMTP log, and determine that one of said plurality of interconnected machines has a possible infection by an e-mail based computer virus based on an analysis of said information comprised in a plurality of said log entries.

12. The mail gateway system of claim 11 wherein said information comprised in each of said log entries includes a unique identity of a sending machine of said corresponding item of incoming e-mail, and further includes one or more of
(a) a name that said sending machine of said corresponding item of incoming e-mail calls itself,
(b) a “From:” address of said corresponding item of incoming e-mail, and
(c) an indication of whether said corresponding item of incoming e-mail contains a potentially virus-like attachment.

13. The mail gateway system of claim 12 wherein said unique identity of said sending machine comprises an Internet Protocol address.

14. The mail gateway system of claim 12 wherein said information comprised in each of said log entries includes said name that said sending machine calls itself, and wherein said name that said sending machine calls itself comprises a “hello” name in accordance with a Simple Mail Transfer Protocol.

15. The mail gateway system of claim 12 wherein said information comprised in each of said log entries includes said potentially virus-like attachment, and wherein said potentially virus-like attachment comprises an executable file.

16. The mail gateway system of claim 12 wherein said analysis of said information comprised in a plurality of said log entries comprises calculating, for a given one of said sending machines, one or more of
(a) a number of different values of said names that said given one of said sending machines calls itself which are included in one or more items of incoming e-mail from said given one of said machines which have been received over one or more specified periods of time,
(b) a number of different values of said “From:” addresses included in one or more items of incoming e-mail from said given one of said machines which have been received over one or more specified periods of time, and
(c) a number of items of incoming e-mail from said given one of said machines which contain a potentially virus-like attachment and which have been received over one or more specified periods of time.

17. The mail gateway system of claim 16 wherein said analysis of said information comprised in a plurality of said log entries comprises calculating, for a given one of said sending machines,
(i) a number of different values of said names that said given one of said sending machines calls itself which are included in one or more items of incoming e-mail from said given one of said machines which have been received over a period of one week,
(ii) a number of different values of said names that said given one of said sending machines calls itself which are included in one or more items of incoming e-mail from said given one of said machines which have been received over a period of twelve hours,
(iii) a number of different values of said “From:” addresses included in one or more items of incoming e-mail from said given one of said machines which have been received over a period of one month,
(iv) a number of different values of said “From:” addresses included in one or more items of incoming e-mail from said given one of said machines which have been received over a period of a half hour,
(v) a number of items of incoming e-mail from said given one of said machines which contain a potentially virus-like attachment and which have been received over a period of one day, and
(vi) a number of items of incoming e-mail from said given one of said machines which contain a potentially virus-like attachment and which have been received over a period of one hour.

18. The mail gateway system of claim 17 wherein said given one of said sending machines is determined to have a possible infection by an e-mail based computer virus when
(a) said number of different values of said names that said given one of said sending machines calls itself which are included in one or more items of incoming e-mail from said given one of said machines which have been received over a period of twelve hours is greater than one, and
(b) said given one of said sending machines is not a mail gateway system.

19. The mail gateway system of claim 17 wherein said given one of said sending machines is determined to have a possible infection by an e-mail based computer virus when
(a) said number of items of incoming e-mail from said given one of said machines which contain a potentially virus-like attachment and which have been received over a period of one hour is greater than zero, and
(b) said given one of said sending machines is not a mail gateway system.

20. The mail gateway system of claim 17 wherein said given one of said sending machines is determined to have a possible infection by an e-mail based computer virus when
(a) said number of different values of said “From:” addresses included in one or more items of incoming e-mail from said given one of said machines which have been received over a period of a half hour is greater than the quotient of said number of different values of said “From:” addresses included in one or more items of incoming e-mail from said given one of said machines which have been received over a period of one month divided by seven, and
(b) said number of different values of said “From:” addresses included in one or more items of incoming e-mail from said given one of said machines which have been received over a period of a half hour is greater than five.
